(19) United States
(12) Patent Application Publication
(10) Pub. No.: US 2007/0279710 A1
(43) Pub. Date: Dec. 6, 2007

(54) DUPLEX SCANNING APPARATUS

(75) Inventors: Chung-Kai Wang, Taipei (TW); Chien-Kuo Kuan, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/532,242

(22) Filed: Sep. 15, 2006

(30) Foreign Application Priority Data
Jun. 2, 2006 (TW) 095119543

(51) Int. Cl. H04N 1/04

(52) U.S. Cl. 358/498

(57) ABSTRACT

A duplex scanning apparatus includes a first scanning module, a second scanning module, a pickup roller assembly, a first feeding roller assembly, a second feeding roller assembly, an discharging roller assembly and a position sensor. The first scanning module is used for scanning a first side of a document. The second scanning module is used for scanning a second side of a document. The roller assemblies are used for transporting the document. The position sensor is used for sensing entrance of the document. By enhancing space utilization of the second scanning module, the overall volume of the duplex scanning apparatus is decreased.

### FIELD OF THE INVENTION

The present invention relates to a duplex scanning apparatus, and more particularly to a duplex scanning apparatus having two scanning modules.

### BACKGROUND OF THE INVENTION

Image scanners are widely used for scanning images of documents, photographs or films. The scanned images can be converted into an electronic file, and then stored or processed in a computer. With increasing development of scanning technologies, the image scanners have experienced great growth and are now rapidly gaining in popularity. The trends of designing the image scanners are toward increased revolutions and enhanced scanning qualities as well as increased scanning speed and reduced overall volume.

In the early stage, the image scanner can scan one side of the document. For scanning both sides of the document, after one side of the document has been scanned, the document should be manually turned over so as to scan the other side of the document.

Recently, a duplex scanning apparatus was developed for automatically performing a duplex scanning operation to scan both sides of the document.

Generally, the duplex scanning apparatuses are classified into two types. The first type uses only one scanning module to scan both sides of the document. Since there is only one scanning module, a specified mechanism is required to turn over the document after one side of the document has been scanned. For performing the duplex scanning operation by the duplex scanning apparatus, the document needs to pass through the scan region for two or three times. As a consequence, the duplex scanning operation by the duplex scanning apparatus is also referred as a two-pass or three-pass scanning operation. Using this duplex scanning apparatus to perform the duplex scanning operation, however, is time-consuming.

The second type of duplex scanning apparatus has two scanning modules. These two scanning modules are disposed at bilateral sides of the scan region. When the document is transported across the scan region, the two scanning modules simultaneously scan front and back sides of the document. In other words, the document needs to pass through the scan region for only one time to perform the duplex scanning operation. In comparison with the first type, the second type of duplex scanning apparatus has an increased scanning speed.

Referring to FIG. 1, a schematic cross-sectional view of a conventional duplex scanning device with two scanning modules is illustrated. The duplex scanning device comprises an automatic document feeder 101, a glass platform 102, a sheet feeding tray 103, an discharging tray 104, a first scanning module 107, a second scanning module 108, a pickup roller assembly 109, an discharging roller assembly 110, a first feeding roller assembly 105, a second feeding roller assembly 106 and a path 111. The first scanning module 107 is disposed under the glass platform 102. The second scanning module 108 is disposed within the automatic document feeder 101. During the process of performing the duplex scanning process, the document 120 to be scanned is placed in the sheet feeding tray 103, and then the pickup roller assembly 109 transports the document 120 into the path 111. Next, the first feeding roller assembly 105 transports the document 120 across a scanning window 130 above the glass platform 102. Meanwhile, the first scanning module 107 and the second scanning module 108 simultaneously scan the first and second sides of the document 120, respectively. After the whole document 120 has passed through the scanning window 130, the both sides of the document 120 have been scanned. Next, the feeding roller assembly 106 and the discharging roller assembly 110 transport the document 120 to the discharging tray 104.

As previously described, the first scanning module 107 and the second scanning module 108 scan the document 120 through the same scanning window 130. For avoid interference between the light projected from the first scanning module 107 and the light projected from the second scanning module 108, the first scanning module 107 and the second scanning module 108 are not fully aligned with each other. In other words, the second scanning module 108 is arranged above the first scanning module 107, but the central line of the second scanning module 108 is slightly deviated from the central line of the first scanning module 107. As known, reducing the light interference if helpful for preventing the blurred images.

Please refer to FIG. 1 again. During the document 120 is transported across the scanning window 130 above the glass platform 102, the document 120 enters the scanning field of the first scanning module 107 and the first scanning module 107 begins to scan the first side of the document 120. At this moment, the operation of the second scanning module 108 has not been initiated. After the documents is moved to enter the scanning field of the second scanning module 108, the second scanning module 108 begins to scan the second side of the document 120 while the first scanning module 107 is scanning the first side of the document 120.

The conventional duplex scanning device as shown in FIG. 1 further has some drawbacks. For example, since the first scanning module 107 and the second scanning module 108 have to be precisely positioned, the process of assembling these two scanning modules is complicated and time-consuming. Moreover, since the second scanning module 108 scans the document 120 through the scanning window 130, the second scanning module 108 and the transmission device for transmitting the second scanning module 108 should be accommodated within the automatic document feeder 101 corresponding to location of the scanning window 130. For accommodating the second scanning module 108 and the transmission device, the automatic document feeder 101 is very high and the operative space of the duplex scanning device is relatively large.

In views of the above-described disadvantages resulted from the prior art, the applicant keeps on carving unflaggingly to develop an improved duplex scanning apparatus according to the present invention through wholehearted experience and research.

### SUMMARY OF THE INVENTION

It is an object of the present invention to provide a duplex scanning apparatus, in which a scanning module is arranged under the sheet feeding tray and thus the height and the operative space are reduced.

In accordance with an aspect of the present invention, there is provided a duplex scanning apparatus. The duplex scanning apparatus comprises a flatbed image scanning portion and an automatic document feeder. The flatbed image scanning portion includes a glass platform and a first scanning module for scanning a first side of a document in a first scan region. The automatic document feeder is disposed above the glass platform. The automatic document feeder includes a sheet feeding tray for placing the document therein, a pickup roller assembly for transporting the document into a path, a first feeding roller assembly for transporting the document to the first scan region through the path, a second feeding roller assembly for transporting the document to a second scan region through the first scan region, an discharging roller assembly for transporting the document into an discharging tray through the second scan region, a position sensor disposed in the second scan region for sensing entrance of the document, and a second scanning module for scanning a second side of the document in the second scan region. The second scan region is arranged between the second feeding roller assembly and the discharging roller assembly.

Preferably, the second scanning module is a contact image sensor (CIS) module.

In an embodiment, the second scanning module is disposed under the sheet feeding tray.

In accordance with another aspect of the present invention, there is provided an automatic document feeder of a duplex scanning apparatus. The duplex scanning apparatus further includes a flatbed image scanning portion having a first scanning module for scanning a first side of a document in a first scan region. The automatic document feeder comprises a sheet feeding tray, a pickup roller assembly, a first feeding roller assembly, a second feeding roller assembly, an discharging roller assembly, a position sensor and a second scanning module. The sheet feeding tray is used for placing therein a document to be scanned. The pickup roller assembly is used for transporting the document into a path. The first feeding roller assembly is used for transporting the document to the first scan region through the path. The second feeding roller assembly is used for transporting the document to a second scan region through the first scan region. The discharging roller assembly is used for transporting the document into an discharging tray through the second scan region. The second scan region is arranged between the second feeding roller assembly and the discharging roller assembly. The position sensor is disposed in the second scan region for sensing entrance of the document. The second scanning module is used for scanning a second side of the document in the second scan region.

Preferably, the second scanning module is a contact image sensor (CIS) module.

In an embodiment, the second scanning module is disposed under the sheet feeding tray.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view of a conventional duplex scanning device with two scanning modules; and

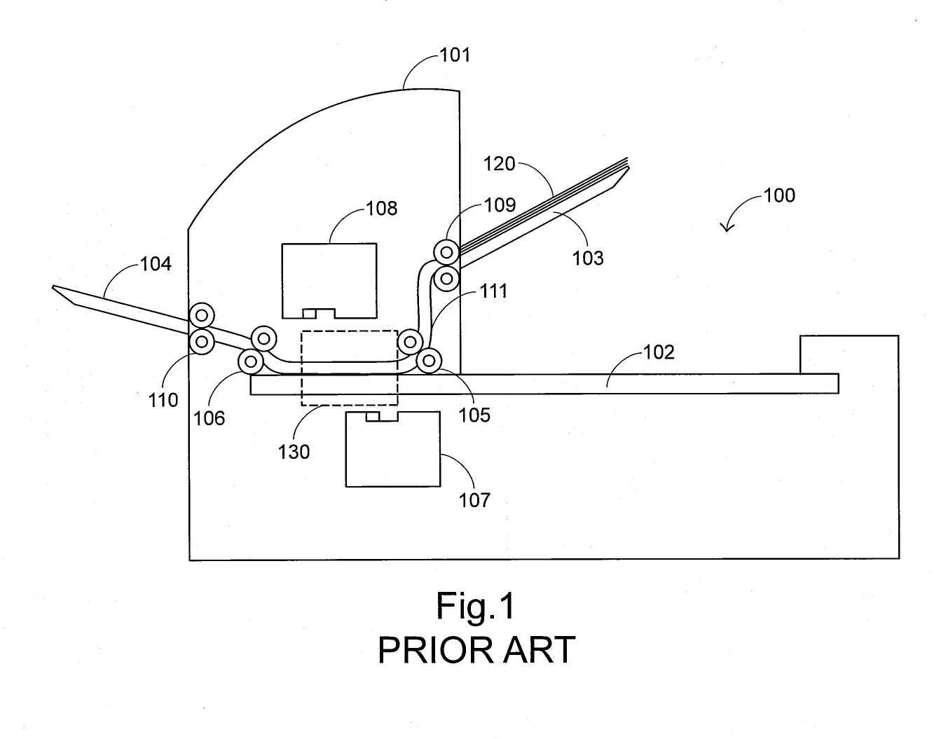

FIG. 2 is a schematic cross-sectional view of a duplex scanning apparatus according to a preferred embodiment of the present invention.

### DETAILED DESCRIPTION OF THE PREFERRED EMBODIMENT

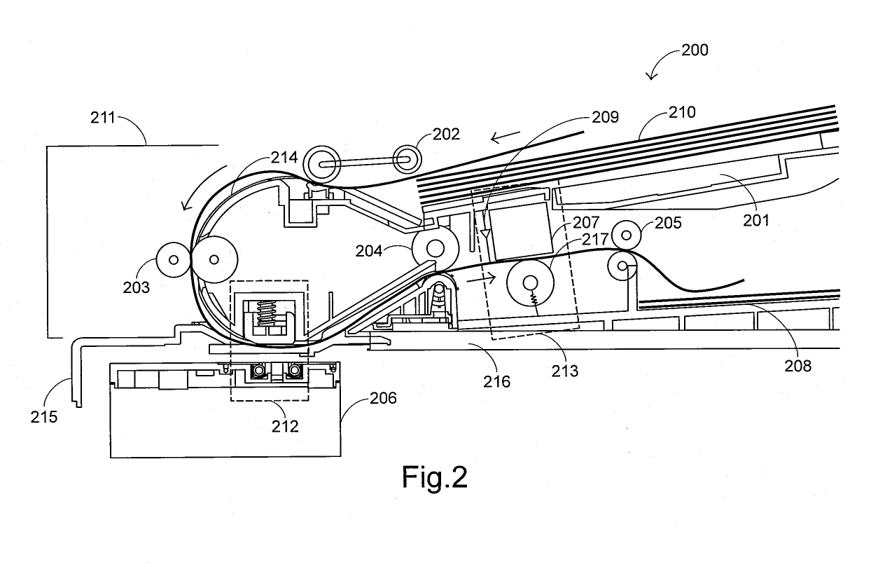

Referring to FIG. 2, a schematic cross-sectional view of a duplex scanning apparatus according to a preferred embodiment of the present invention is illustrated. The duplex scanning apparatus 200 as shown in FIG. 2 comprises an automatic document feeder 211 and a flatbed image scanning portion 215. The automatic document feeder 211 comprises a sheet feeding tray 201, a pickup roller assembly 202, a first feeding roller assembly 203, a second feeding roller assembly 204, an discharging roller assembly 205, a first scan region 212, a second scan region 213, an discharging tray 208, a position sensor 209, a path 214, a second scanning module 207 and a pressing roller 217. The flatbed image scanning portion 215 comprises a first scanning module 206 and a glass platform 206. It is preferred that the second scanning module is a contact image sensor (CIS) module. In addition, a position sensor 209 is disposed in the first scan region 212 for detecting whether the document 210 enters the second scan region 213.

Please refer to FIG. 2 again. Hereinafter, the procedure of performing a duplex scanning operation by using the duplex scanning apparatus 200 of the present invention is illustrated. First of all, the document 210 to be scanned is placed in the sheet feeding tray 201. The pickup roller assembly 202 transports the document 210 into the first path 214, and then the first feeding roller assembly 203 transports the document 210 across the first scan region 212. When the document 210 is transported across the first scan region 212, the first scanning module 206 under the first scan region 212 scans the first side of the document 210. Next, the second feeding roller assembly 204 transports the document 210 to the second scan region 213. When the position sensor 209 disposed in the first scan region 212 detects that the document 210 enters the second scan region 213, the second scanning module 207 begins to scan the second side of the document 210 unit the document 210 exits the second scan region 213. Next, the discharging roller assembly 205 transports the document 210 into the discharging tray 208. Meanwhile, the duplex scanning operation has been completed.

From the above embodiment, the first scanning module 206 and the second scanning module 207 are disposed in the flatbed image scanning portion 215 and the automatic document feeder 211, respectively. In other words, since the second scanning module is no longer disposed above the first scanning module, it is not necessary to precisely position the first scanning module 206 and the second scanning module 207. As a consequence, the process of assembling these two scanning modules is simplified and time-saving. Moreover, since the second scanning module 207 is accommodated within the operative space under the sheet feeding tray 201, which is originally unoccupied, the space utilization of the duplex scanning apparatus is enhanced. In addition, since the number of the components above first scan region 212 is reduced, the height of the automatic document feeder 211 is decreased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A duplex scanning apparatus comprising:
a flatbed image scanning portion including a glass platform and a first scanning module for scanning a first side of a document in a first scan region; and
an automatic document feeder disposed above said glass platform and including a sheet feeding tray for placing said document therein, a pickup roller assembly for transporting said document into a path, a first feeding roller assembly for transporting said document to said first scan region through said path, a second feeding roller assembly for transporting said document to a second scan region through said first scan region, an discharging roller assembly for transporting said document into an discharging tray through said second scan region, a position sensor disposed in said second scan region for sensing entrance of said document, and a second scanning module for scanning a second side of said document in said second scan region, wherein said second scan region is arranged between said second feeding roller assembly and said discharging roller assembly.

2. The duplex scanning apparatus according to claim 1 wherein said second scanning module is a contact image sensor (CIS) module.

3. The duplex scanning apparatus according to claim 1 wherein said second scanning module is disposed under said sheet feeding tray.

4. An automatic document feeder of a duplex scanning apparatus, said duplex scanning apparatus further including a flatbed image scanning portion having a first scanning module for scanning a first side of a document in a first scan region, said automatic document feeder comprising:
a sheet feeding tray for placing therein a document to be scanned;
a pickup roller assembly for transporting said document into a path;
a first feeding roller assembly for transporting said document to said first scan region through said path;
a second feeding roller assembly for transporting said document to a second scan region through said first scan region;
an discharging roller assembly for transporting said document into an discharging tray through said second scan region, wherein said second scan region is arranged between said second feeding roller assembly and said discharging roller assembly;
a position sensor disposed in said second scan region for sensing entrance of said document; and
a second scanning module for scanning a second side of said document in said second scan region.

5. The automatic document feeder according to claim 4 wherein said second scanning module is a contact image sensor (CIS) module.

6. The automatic document feeder according to claim 4 wherein said second scanning module is disposed under said sheet feeding tray.
